(19) United States
(12) Patent Application Publication
(10) Pub. No.: US 2010/0043251 A1
(43) Pub. Date: Feb. 25, 2010

(54) HEAT TREATMENT PROCESS FOR A MATERIAL AND HEAT TREATMENT UNIT IMPLEMENTING SUCH PROCESS

(75) Inventor: Patrick Delaine, Saint Doulchard (FR)

Correspondence Address: OLIFF & BERRIDGE, PLC, P.O. BOX 320850, ALEXANDRIA, VA, 22320-4850, US

(73) Assignee: NEXTER MUNITIONS, VERSAILLES (FR)

(21) Appl. No.: 12/311,799

(22) PCT Filed: Oct. 22, 2007
(86) PCT No.: PCT/FR2007/001739

§ 371 Date: Sep. 17, 2009

(30) Foreign Application Priority Data
Oct. 25, 2006 (FR) 0609357

(51) Int. Cl. F26B 23/02; F26B 21/10; F26B 3/04

(52) U.S. Cl. 34/471; 34/468; 34/516; 34/72; 34/79; 34/201

(57) ABSTRACT

The invention relates to a heat treatment process for a material in an oven (4), such process using the combustion gases supplied by at least one burner (5) associated with a firebox (6). This process is characterised in that a first condensation phase is provided for the combustion gases between their exiting the firebox (6) and entering the oven (4), such condensation enabling part of the dust contained in the combustion gases to be eliminated, the first condensation phase being conducted using absorption refrigerating means (14) followed by a superheating phase of the combustion gas allowing the required temperature to be obtained for the heat treatment.

The invention also relates to a treatment unit implementing such process.

The process is more particularly applicable to the heat treatment of wood.

The technical scope of the invention is that of heat treatment processes for a material in an oven, and more particularly that of treatment processes for an organic material such as wood.

It is conventional to subject organic materials to heat treatments so as, for example, to dehydrate them or confer them with certain properties.

More particularly, it is known to dry the wood in industrial ovens heated to a temperature of around a hundred degrees or so.

It is also known to subject wood to heat treatments at temperatures of between 120° C. and 230° C. The purpose of these treatments is to eliminate different volatile organic compounds from the wood, thereby improving the subsequent conservation of the wood and preventing it from subsequently rotting or being attacked by insects.

The temperature and duration of the heat treatment depends on the type of wood in question and its degree of humidity.

One of the difficulties of such a treatment lies in that it must be conducted in an industrial oven having an oxygen-depleted atmosphere (oxygen level of less than 5% in mass). Indeed, a higher level would lead to the spontaneous combustion of the heated wood.

It is furthermore necessary to control the cooling of the wood after treatment also at a reduced level of oxygen to avoid combustion.

Known processes use the combustion gases from a gas, fuel oil or wood-fuelled boiler.

A reduced level of oxygen is thus certain to be obtained.

However, combustion gases carry unburned residues and hot dust which can lead to the ignition of the wood and which impregnate it thereby deteriorating its quality and reducing its subsequent sales value. Dust and solid residues are particularly abundant namely when the combustible is itself wood.

Patent U.S. Pat. No. 3,675,600 describes a known treatment process in which different chambers are provided in which the combustion gases circulate before being directed towards the oven itself.

These chambers enable the impurities to be incinerated at high temperature thereby eliminating them from the gas flow being used.

This process suffers from drawbacks.

Firstly, the elimination of the impurities is incomplete and depends on the number of post-combustion chambers as well as on the oxygen level in these chambers.

It is furthermore difficult to control the level of oxygen in the gas produced using this process.

Indeed, an intake of fresh air is required to enable the elimination by combustion of the different impurities thereby increasing the oxygen level in the gaseous flow that is produced with the risk of causing to wood to be treated to ignite.

Lastly, this process does not enable the heat-energy that is produced to be fully utilized. Indeed, the multiplication of post-combustion chambers leads to heat loss.

Patent U.S. Pat. No. 4,888,884 also proposes to operate a filtering of the combustion gases downstream of the oven. Such filtering is combined with the recirculation of the combustion gases in a closed circuit and thus enables the oxygen level of the gas implemented to be controlled.

However, downstream filtering does not enable the particles to be eliminated before their introduction into the oven, the quality of the material obtained by such treatment is thus not satisfactory.

We also note that the treatment described in this patent is more particularly intended for the treatment of semi-pulverulent material such as wood chippings. It is difficult to transpose such treatment to bulky materials such as planks or logs.

A process is also known by patent WO81/00147 in which the solvents contained in the gases exiting the drying oven are eliminated by condensation. However, this process is intended for a drying oven for the printing industry in which the gas temperatures are largely below those required to treat wood.

Patent WO2005/116551 proposes a wood treatment device in which the gas exiting a firebox is condensed so as to eliminate the presence of any water. However, such condensation is made downstream of a heat exchanger. The level of condensation obtained thus does not enable the combustion gases to be cleaned enough to perform wood treatments.

The aim of the invention is to propose a heat treatment process that firstly enables the particles carried by the combustion gases to be eliminated and secondly enables the oxygen level of the gas implemented to be controlled.

The process according to the invention further enables an optimization in the use of the energy implemented. It is thus able to function continually and enables the treatment of large volumes of wood.

The heat energy is used optimally. Furthermore, the residues are recovered and may be reused or upgraded.

Thus, the invention relates to a heat treatment process for a material in an oven, and namely an organic material such as wood, process using the combustion gases supplied by at least one burner associated with a firebox, process wherein a first condensation phase is provided for the combustion gases between their exiting the firebox and entering the oven, such condensation enabling part of the dust contained in the combustion gases to be eliminated, the first condensation phase being conducted using absorption refrigerating means followed by a superheating phase of the combustion gas allowing the required temperature to be obtained for the heat treatment.

Such superheating may be performed using the gases supplied by a hot gas generator which is itself heated by the burner.

Such superheating may be made via an exchanger heated by the burner.

The temperature of the combustion gases used for the treatment may be advantageously regulated by mixing gases exiting the superheating phase with those from the first condensation phase.

A second condensation phase may be performed at the oven outlet.

The second condensation phase may be followed by a phase to separate the solid and/or liquid fraction and the combustion gases themselves.

Advantageously, the combustion gases may be redirected after exiting the separation phase towards the burner and/or the firebox, by means of a mixing phase that ensures the mixture of the gases and the air, such mixture being proportioned as a function of the measurement of the level of at least one combustible included in the combustion gases.

The invention also relates to a heat treatment unit for a material, and namely for an organic material such as wood, such unit enabling the process according to the invention to be implemented.

This unit comprises at least one oven, heated by combustion gases from at least one burner associated with a firebox, wherein it incorporates at least a first condenser that is arranged so as to cool the combustion gases exiting the firebox, such condensation enabling part of the dusts contained in the combustion gases to be eliminated with the water, such dusts being recovered by decantation means, such unit incorporating at least one superheater linked to heating means and enabling the combustion gases to be heated after exiting the first condenser, and also incorporating at least one absorption refrigerating means that uses the firebox as a heat source and that comprises at least one cooling circuit coupled with the first condenser.

The heating means may be linked to the superheater by means of temperature regulation means for the combustion gases.

The heating means may be linked to a hot gas generator, which will itself be heated by the burner(s).

The superheater may comprise at least two hot gas circulation circuits arranged in a chamber through which the combustion gases circulate, the circuits being arranged such that the combustion gases circulate in the opposite direction to the hot gases supplied by the gas generator, each circuit being furthermore equipped with a valve to regulate the gas flow, whose opening is controlled by the temperature regulation means.

The superheater may be constituted by an exchanger heated by the burner itself.

According to a variant embodiment, the exchanger forming the superheater may incorporate manifolds which will be structurally incorporated into a hot gas generator.

Advantageously, the temperature regulation means for the combustion gases may comprise two circuits: one circuit for the cold combustion gases from the first condenser and another circuit for the hot combustion gases from the superheater, the temperature of the combustion gases used being regulated by at least one mixing valve ensuring the mixture of the cold and hot gases.

Each hot and cold circuit will incorporate a pump, the pump rate being regulated so as to ensure the equality of the combustion gas flow upstream and downstream of the superheater.

Each circuit of hot or cold combustion gases will preferably incorporate a balance circuit enabling any drop in pressure caused by the mixing valve to be compensated for, such balance circuit re-injecting part of the hot or cold gases upstream of the pump of the circuit in question.

The unit may incorporate at least a second condenser which will be arranged at the oven outlet.

The treatment unit may advantageously comprise decantation means enabling the solid and/or liquid fraction to be separated from the gases themselves.

The heat treatment unit may also comprise a mixing phase that will ensure the mixing with air of the gases exiting the second condenser and the decantation means, this mixing phase incorporating at least one valve whose opening will be controlled by regulation means that will control the degree to which the valve opens according to the measurement of the level of at least one combustible component included in the combustion gases, the mixture of air and combustion gases being redirected towards the burner and/or the firebox.

Advantageously, at least one cooling circuit for the absorption refrigerating means may also be coupled with the second condenser.

According to another characteristic, the hot gas generator may be supplied with air via a third condenser connected to a cooling circuit of the absorption refrigerating means.

When the heat treatment unit according to the invention is more particularly intended for the treatment of wood, it will advantageously comprise at least one oven that will incorporate two lateral walls opposite one another and an upper wall, such walls being made in the form of box structures in which the combustion gases will circulate, the latter being brought to the upper box structure which will be divided into two half-box structures, one half-box structure receiving the combustion gases from the oven and the other half-box structure collecting the gases for their evacuation after their passage in the oven, each half-box structure furthermore communicating with a separate lateral box structure, the walls of the lateral box structures being provided with perforations enabling the gases from the lateral box structure to pass into the inside of the oven, the gases being thus introduced in the oven by a lateral box structure and being evacuated from the oven by the other lateral box structure.

Advantageously, the upper box structure will be roughly parallelepipedic in shape and will be divided into four compartments by two partitions which will extend diagonally, a first compartment being linked to a combustion gas inlet pipe and a second compartment being linked to a combustion gas outlet pipe, the two other compartments each being linked to one of the lateral box structures, a median pivoting shutter may be positioned in the prolongation of one or other of the diagonal partitions so as to divide the upper box structure into two half-box structures. The pivoting shutter will thus enable the combustion gases to be directed selectively either towards one or other of the lateral box structures.

According to another characteristic of the invention, the lateral box structures may be provided with perforations which will be spaced over the full height of each box structure, each lateral box structure being furthermore equipped with a vertically sliding panel that, depending on the position selected, will enable all the perforations of an upper half or else all those of a lower half of said lateral box structure to be blocked, the panels being furthermore positioned in the upper position on one lateral box structure and in the lower position on the other lateral box structure depending on the position of the pivoting shutter in the upper box structure. The positioning of the panels will be selected so as to constantly ensure a flow of combustion gases that will pass through the oven from a lower part of a lateral box structure towards an upper part of the other lateral box structure.

According to another embodiment, the oven incorporates two lateral walls opposite one another, walls which are made in the form of box structures in which the combustion gases flow, each lateral wall being divided into two half-box structures, a lower box structure intended to receive the combustion gases from the oven and an upper box structure collecting the gases for their evacuation after their passage in the oven, one three-way valve being positioned upstream of the lower box structure and another three-way valve being positioned downstream of the upper box structures so as to ensure, through the activation of the two valves, the control of the direction in which the gases pass from one partition towards the other partition.

According to one characteristic, downstream of the second condenser it is possible to provide at least one ventilation unit coupled with a venturi that enables the oven to be maintained at negative atmospheric pressure, a valve positioned downstream of the oven enabling the gas flow through the oven to be regulated.

Other characteristics and advantages of the invention will become apparent from the following description of a particular embodiment, such description made with reference to the appended drawings, in which:

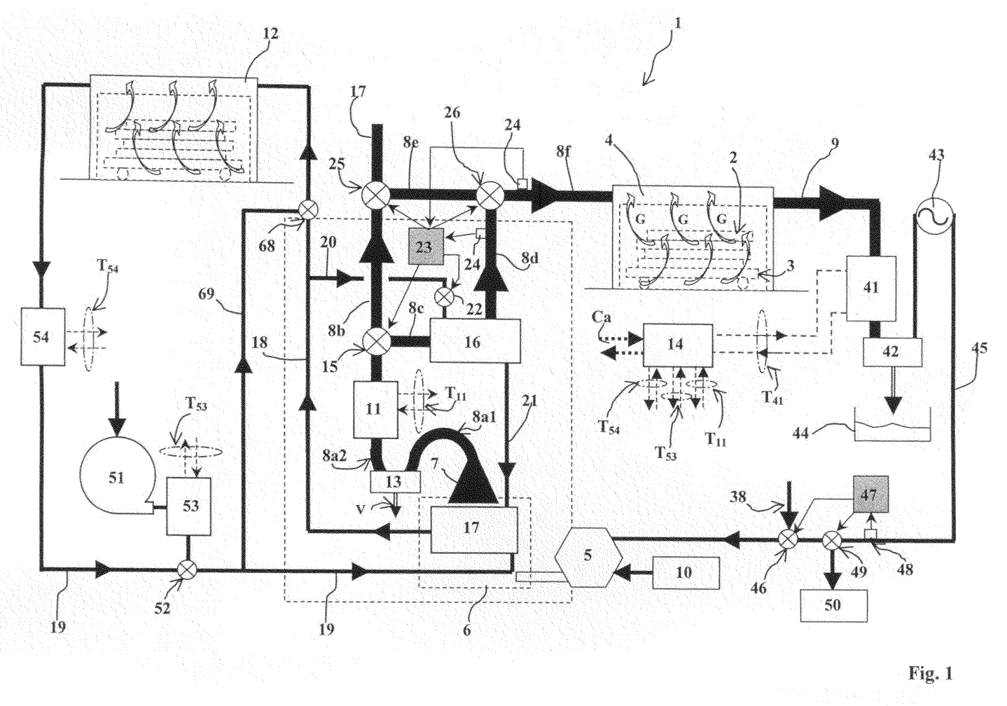

FIG. 1 is a general block diagram of a treatment unit according to the invention,

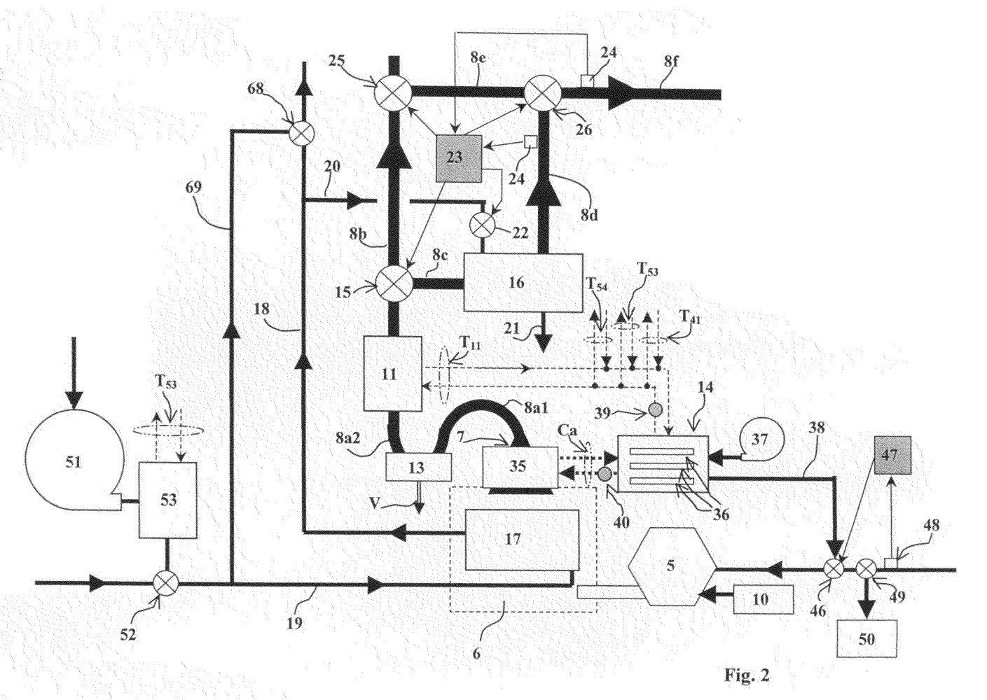

FIG. 2 is a detailed view of the combustion gas generator of this heat treatment unit,

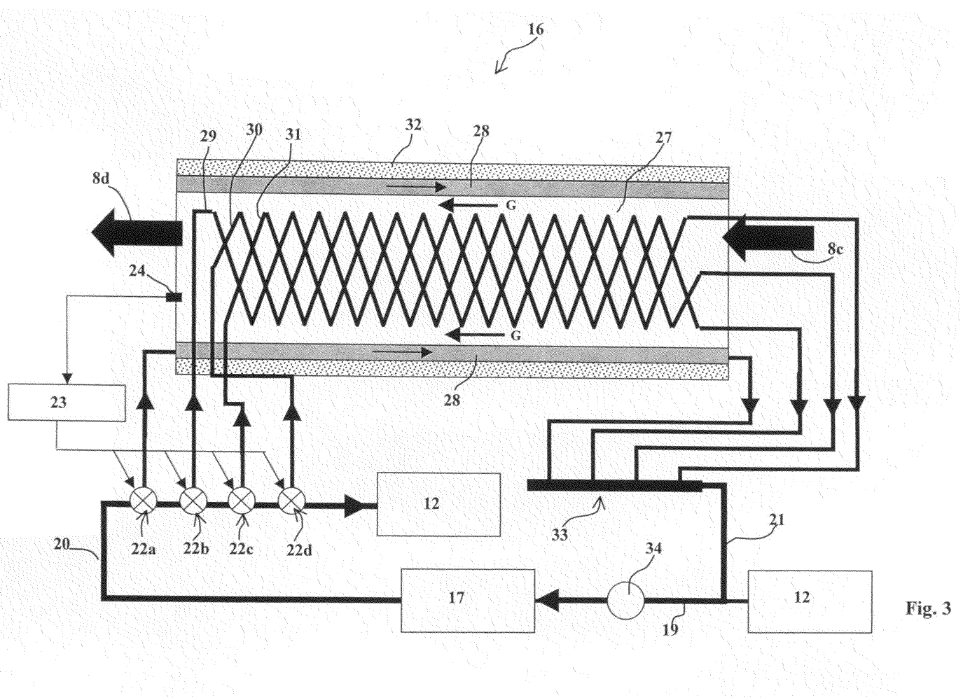

FIG. 3 is a schematic view of one embodiment of the superheater,

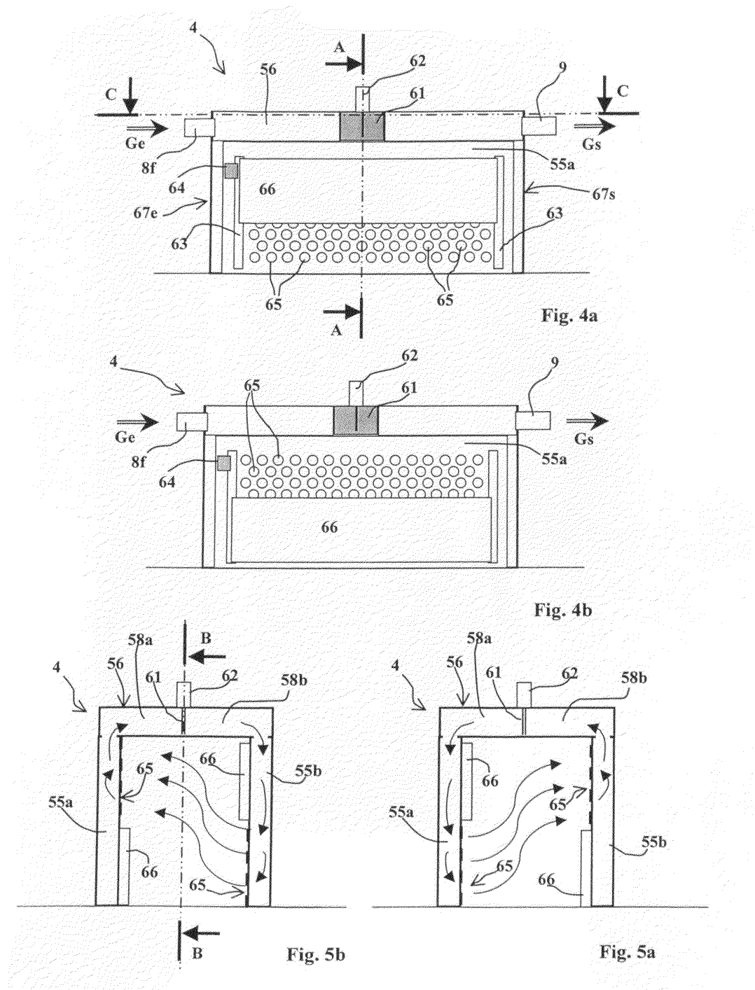

FIGS. 4a and 4b are two simplified longitudinal sections of an oven implemented in the unit according to the invention, the sections are made according to the planes referenced BB in FIG. 5a, each Figure furthermore shows the oven in a different position for the gas circulation means,

FIGS. 5a and 5b are two simplified cross section views of this oven, the sections are made according to the plane referenced AA is FIG. 4a, FIG. 5a furthermore showing the oven in the same position as in FIG. 4a and similarly FIG. 5b may be associated with FIG. 4b,

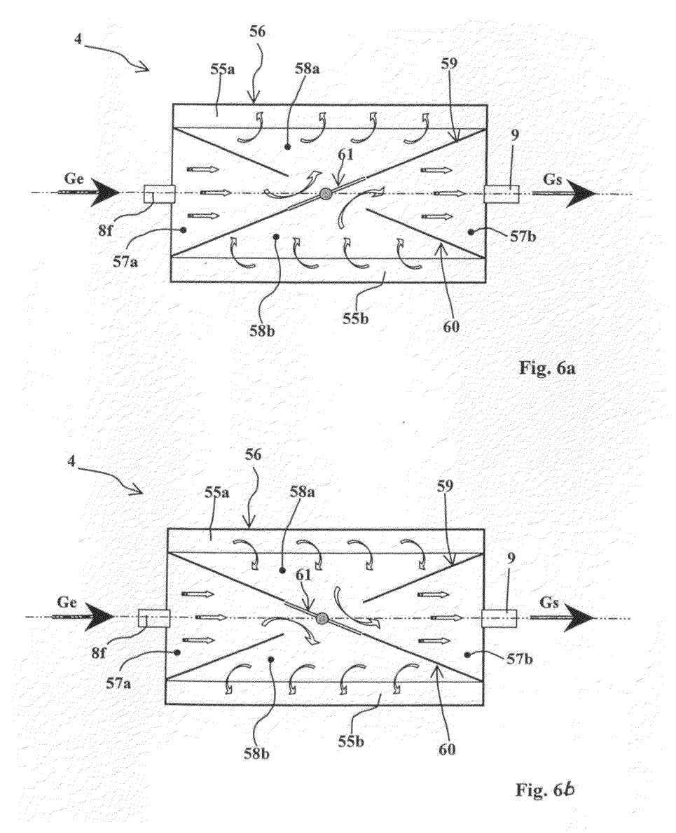

FIGS. 6a and 6b are lastly two top views of the oven, the oven is sectioned at its upper box structure (plane of the section referenced CC in FIG. 4a), FIG. 6a shows the oven in the same position as in FIGS. 4a and 5a, and FIG. 6b shows the oven in the same position as in FIGS. 4b and 5b,

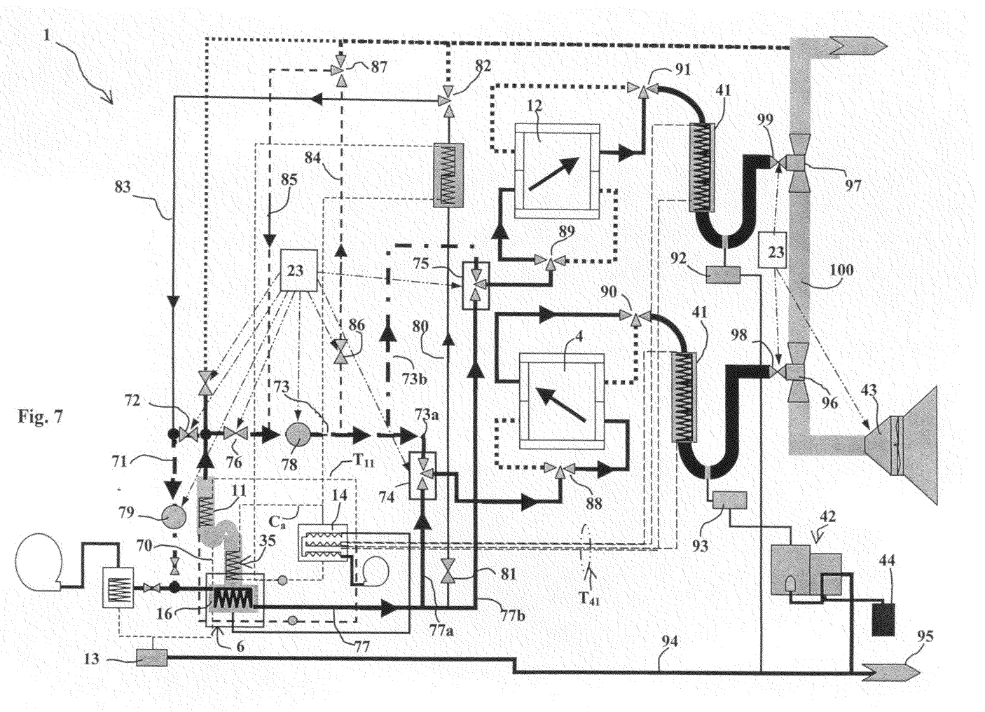

FIG. 7 is a general block diagram of a treatment unit according to another embodiment of the invention,

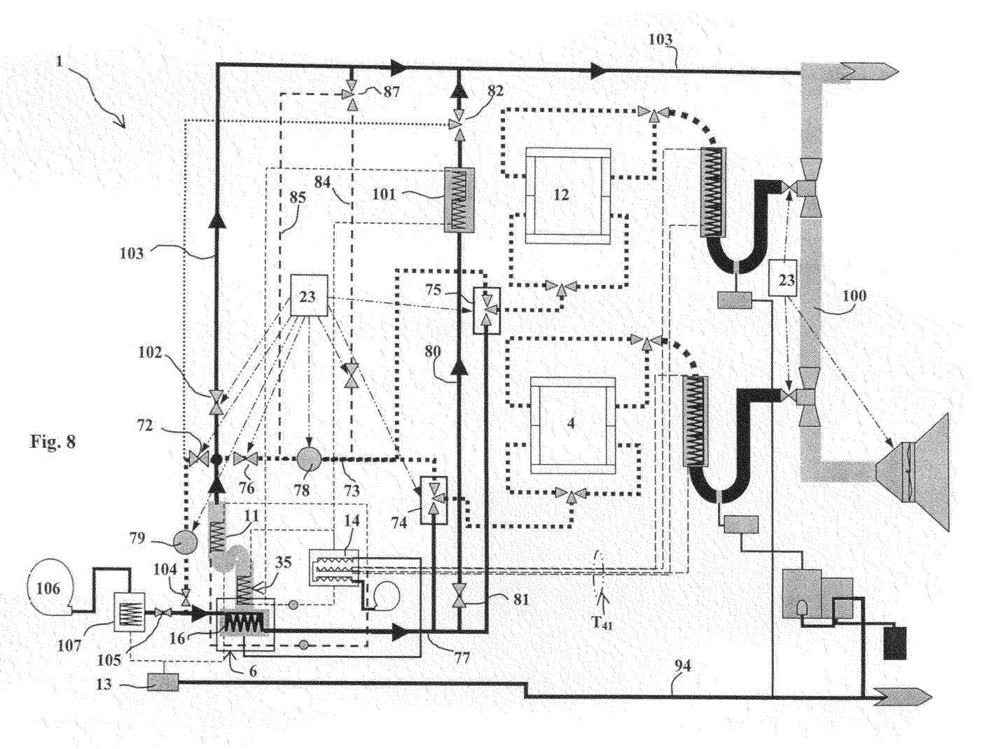

FIG. 8 is a diagram showing this same unit and enabling its functioning to be highlighted in the starting phase,

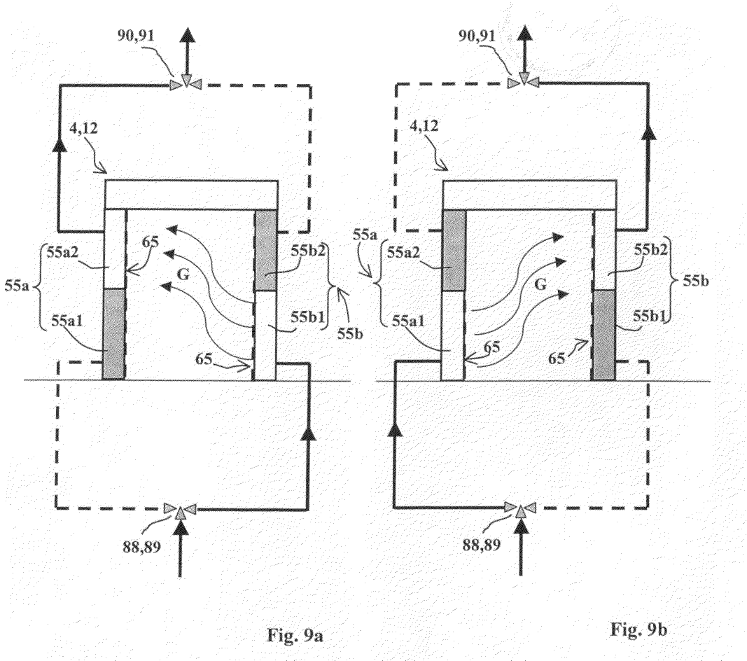

FIGS. 9a and 9b are two simplified cross section views of another embodiment of the oven.

FIG. 1 shows a wood heat treatment unit. The wood 2 is placed on carriages 3 which are housed in the heat treatment ovens 4. Here a single oven 4 is shown, but the unit may be dimensioned to comprise several ovens.

The ovens 4 are large-sized units able to treat wood elements of around 6 m in length (logs or sawn wood). The wood that is to be treated at high temperature will previously have been dried in a drying oven 12 (in which the temperature is of around 100° C.). To be able to be treated, the wood will preferably have a humidity level of less than 12%.

Each oven 4 is thus roughly in the form of a parallelepipedic rectangle 10 metres long, 3 metres wide and 5 metres high.

The oven 4 is heated using combustion gases from a burner 5 associated with a combustion firebox 6. This mode of heating by combustion gases enables the required reduced oxygen level to be controlled.

The gases are recovered upon their exiting the firebox 6 by a collector 7 and are directed towards the oven by ducts: 8a1, 8a2, 8b, 8c, 8d, 8e, 8f.

The gases G circulate in the oven (whose internal structure will be described later). They are then evacuated after exiting the oven 4 by a duct 9.

The burner 5 uses a source of combustible 10 which may be gas or fuel oil or, advantageously, the residues and wood chippings that may be recovered at the facility. Preferably, a poly-combustible burner 5 will therefore be used.

According to an important characteristic of the invention, the unit will incorporate at least a first condenser 11, which is arranged so as to cool the combustion gases upon their exiting the firebox 6.

The condenser 11 causes the sudden cooling of the gases upon their exiting the firebox 6. This cooling causes the water contained in the gases to condense. This water runs along duct 8a2 and carries with it most of the dust contained in the combustion gases.

The water runs along the duct 8a2 and accumulates with the dust in decantation means 13.

In practical terms, the decantation means will be constituted by a tank in which the combustion gases circulate. Ducts 8a1 and 8a2 both open out into the tank by its upper wall. The dust-laden water accumulates in the tank 13 and is periodically drawn off by means of a valve V, so as to be retreated and to have the residues removed.

The condenser 11 is linked to refrigerating means 14 by manifolds T11 which conduct a heat-conducting fluid.

In practical terms, the temperature of the combustion gases is of around 210° C. after exiting the firebox 6. The condenser 11 is dimensioned to lower this temperature to around 80° C. For this, it merely requires refrigerating means carrying a fluid circulating at a temperature of around 5° C. and the exchange surfaces of the condenser and refrigerating means 14 will be dimensioned to enable the required drop in temperature.

Water may be used as the heat-conducting fluid.

A three-way valve 15 is positioned at the condenser outlet 11. This valve enables the combustion gases to be directed towards the duct 8c which leads to a superheater 16 or else to duct 8b which enables the gases to be directed towards an exhaust shaft 17.

The superheater 16 is essential to bring the combustion gases to the temperature necessary for the wood heat treatment (temperature of between 180° C. and 230° C.).

The heat supplied by the superheater 16 also comes from the firebox 6 but via a separate heating means.

In accordance with the invention, the heating means comprises a hot gas generator 17 which is itself heated by the burner 5.

The gas generator 17 is arranged in the firebox 6 and comprises manifolds that enclose the gas to be heated (for example air). These manifolds enable the gas to be heated to be physically isolated from the combustion gases, but they are made of a good heat conducting material (for example metal).

These manifolds enable the heat supplied by the firebox to be transferred to the gas circulating inside the manifolds.

The number of manifolds is selected to provide sufficient heat exchange surfaces and several sets of manifolds will be provided so as to ensure that the gas is kept inside the firebox 6 for long enough for its temperature to reach a high level (of around 600° C.).

One example of a hot gas generator is given by patent application FR06-05589.

The hot gases generated by the generator 17 exit the latter by piping 18. After use, the gases return to the generator by piping 19. The hot gases are used in the facility for example to supply the drying oven(s) 12.

The temperature of the hot gases required for the drying process in the drying oven 12 is regulated using a valve 68 which enables the hot gases generated by the generator 17 to be mixed with part of the cooled gases taken from the return piping 19 by means of piping 69.

The opening of the valve 68 will be regulated using electronic control means (not shown) associated with a gas temperature sensor at the inlet to the oven 12 (not shown). The gas temperature may thus easily be brought from 600° C. at the outlet to the generator 17 to around 100° C. at the inlet to the oven 12.

The high temperature (600° C.) hot gases are furthermore used by the superheater 16.

A branch 20 of piping 18 in fact enables part of the hot gases to be conducted toward the superheater 16. The hot gases will exit the superheater 16 by piping 21 which will take them back to the generator 17.

Means to regulate the temperature are positioned between the gas generator 17 and the superheater 16.

These means comprise a valve 22 that is activated by electronic temperature regulation means 23. These means 23 are furthermore linked to a sensor 24 measuring the temperature of the combustion gases circulating in the outlet duct 8d of the superheater 16.

Thus, the electronic means 23 may be made in the form of a programmable microcomputer. In this case, the opening of the valve 22 can be piloted as a function of the required temperature set points for the gases intended for the oven 4.

It is clear that opening the valve 22 causes an increase in the flow of hot gas from the generator 17 circulating in the superheater 16 and thus also an increase in the temperature of the combustion gases G directed to the oven 4 by the duct 8f.

We note that the combustion gases from the condenser 11 have a relatively low temperature (of around 80° C.). It is thus possible and easy to regulate the temperature of the gases directed to the oven 4 over a fairly wide range (from around 80° C. to 300° C.).

By simply programming means 23, it is possible to activate an increase in the oven temperature according to the different thresholds required and which are suited to the type of wood to be treated.

It is equally easy to pilot the cooling of the oven in an oxygen-depleted atmosphere and this until a temperature has been reached that will enable the wood to be removed from the oven 4 without the risk of its spontaneous combustion.

For the cooling phases of the oven 4, it is possible to directly use the gases exiting the condenser 11 rather than the gases reheated by the superheater 16. For this, it suffices to regulate the opening of different three-way valves.

Thus, two other three-way valves 25 and 26 are provided as well as a duct 8e positioned between these two valves.

Valve 25 enables the combustion gases from the condenser 11 to be oriented towards the oven 4, rather than toward the exhaust shaft 17. It is thus possible for the superheater 16 to be completely isolated and for the combustion gases from the condenser 11 only to be directed towards the oven. Thus, at valve 26 the reduced temperature (80° C.) gases from the condenser 11 can be mixed with the hot gases from the superheater 16.

For this, valve 15 will be positioned so as to supply the two ducts 8a and 8c.

A temperature sensor 24 may be positioned on duct 8f supplying the oven 4. The electronic means 23 will, in this case, ensure the regulation of the opening and closing of valves 15, 25, 26 and 22 as a function of the temperature required for the cooling (or heating) thresholds of the oven.

FIG. 3 shows the structure of a superheater 16 in more detail.

This element comprises a cylindrical chamber 27 inside which the combustion gases G circulate. Arrows 8c and 8d show the direction in which the combustion gases circulate and act as a reminder of the different ducts:

→ inlet to the superheater 16: duct 8c,

→ outlet from the superheater: duct 8d.

The cylindrical chamber 27 is delimited by an inner wall of a ring-shaped duct 28 that is connected to the hot gas generator 17 by means of a valve 22a. This ring-shaped duct 28 constitutes a first circulation circuit for the hot gases in the chamber 27.

The chamber 27 furthermore encloses three other circulation circuits for the hot gases (29, 30 and 31) which are all connected to the hot gas generator 17 by a valve (respectively 22b, 22c and 22d).

These three other circuits are made in the form of manifolds wound in a helix so as to increase the heat exchange surface between the circulation circuits of the hot gases and the combustion gases.

An external wall 32 surrounds the superheater 16. It incorporates heat insulating materials and prevents any heat loss.

All the circulation circuits 28, 29, 30 and 31 are linked downstream by a collector 33 that is connected to piping 21 that directs the gases back to the generator 17.

An accelerator 34 enables the hot gas flow through the different circuits to be regulated.

FIG. 3 shows that the different valves 22a, 22b, 22c and 22d are all controlled by the electronic means 23 which are also connected to a temperature sensor 24 measuring the temperature of the combustion gas as it exits the superheater 16.

FIG. 3 also shows that the different circulation circuits 28, 29, 30 and 31 are arranged such that the combustion gases G circulate in a direction contrary to the direction of circulation of the hot gases from the gas generator 17. Such an arrangement improves the efficiency of the heat transfer.

The combustion gases thus encounter the circulation circuits in the vicinity of the superheater 16 outlet (thus in the place where their temperature is the lowest) and, as they progress through the superheater 16, they encounter hotter and hotter circulation circuits. Such an arrangement is more favourable to heating than the opposite arrangement and leads to a higher temperature for the combustion gases G at the outlet to the superheater.

The division of the superheater 16 into several circulation circuits furthermore enables the amount of heat transferred to the combustion gases G to be more precisely regulated. It is thus easy to regulate the different temperature stages that are required.

Furthermore, the installation of a circulation circuit 28 having a manifold shape enables the thermal efficiency of the superheater to be improved. The combustion gases G in fact circulate in a chamber 27 delimited by a heated duct 28 and they pass though other manifolds (those of circuits 29, 30, 31) which are also superheated.

Depending on the number of circulation circuits implemented, there will be more or less heat transferred to the combustion gases G.

We also note in FIG. 3 that the different circulation circuits 28, 29, 30 and 31 are all connected in series one after the other to the generator 17 and that the drying oven 12 is arranged in series with the superheater 16 and not in parallel as shown in FIGS. 1 and 2.

This assembly in series is a variant of the invention which enables the heat supplied by the gas generator 17 to be better used.

Indeed, the gases from the generator 17 that are cooled through the superheater 16 nevertheless remain at a temperature that is quite high enough to supply one or several drying ovens 12.

The gases may, however, be lowered in temperature before being introduced into the drying oven 12. This lowering in temperature will be piloted as described previously by the hot gases being mixed with part of the cooled gases taken from the return pipe 19.

Naturally (and with suitable dimensioning of the installation) it is possible to provide several superheaters 16 in series one behind the other, in particular to supply several heat treatment ovens 4.

FIG. 2 shows more precisely the structure of the combustion gas generator of the heat treatment unit 1 and in particular the structure of the refrigerating means 14 as well as its different circuits.

Advantageously, and so as to optimise the thermal efficiency of the unit 1, absorption refrigerating means 14 will be implemented. These means are well known to the Expert.

They implement a circulation circuit Ca of a fluid enabling the heat from a hot source to be absorbed by a boiler (more often than not the fluid is an ammoniac solution). This fluid circuit is coupled with an evaporator which causes the fluid to change its state and thus produce cold.

In accordance with the invention, the firebox 6 will be used as a hot source. Thus, for example, a boiler 35 will be positioned around the combustion gas collector 7. The boiler 35 will thus be constituted by manifolds surrounding the collector 7.

The heat-conducting circuit Ca (shown in dotted lines) is the circuit of fluid enabling the heat to be extracted (for example an ammoniac solution). This circuit Ca is linked to one or several exchangers 36 that will ensure the vaporisation of the ammoniac. The fluid ensuring the vaporisation is air that will be introduced into the refrigerating means 14 by means of a ventilator 37.

The air which exits the refrigerating means 14 has been heated by the fluid from the heat-conducting circuit Ca, this heated air is recovered by a pipe 38 and directed towards the burner 5 and/or the firebox 6. This heated air enables the combustion of the burner 5 to be more efficient.

The heat-conducting fluid vaporises at a temperature of around 5° C. (for ammonia). One or several refrigerating circuits are coupled with the heat-conducting circuit CA by one or two exchangers. These circuits are, for example, water circuits. The refrigerated water is conducted by a circuit T11 to the first condenser 11 and ensures (as explained previously) the elimination of the water and dust particles contained in the combustion gases.

The necessary water flow rate is ensured thanks to an accelerator 39.

Another accelerator 40 may be provided additionally on circuit Ca so as to improve the heat exchange efficiency.

This refrigerated water circuit may incorporate other branches which will be described later.

With reference to FIG. 1, we note that the unit 1 comprises a second condenser 41 arranged at the outlet to the oven 4.

The combustion gases G that exit the oven 4 are loaded both with humidity and volatile organic compounds that are extracted from the wood during the heat treatment. These volatile components essentially comprise condensable hydrocarbons, namely methane and acetone.

The condenser 41 enables the water incorporated in the gases at the outlet to the oven to be eliminated as well as the dust or other solid residues.

The decantation means 42 allow the solid and/or liquid fraction to be separated from the combustion gas itself.

The residues are recovered in a tank 44 for subsequent treatment and elimination (along with the residues extracted by means 13).

A ventilator 43 allows the flow rate of the gases in the oven 4 to be regulated. Piping 45 thus only carries cooled combustion gas loaded with volatile organic compounds which are combustible.

This gas is mixed with air during a mixing stage comprising a three-way valve 46 and is then directed towards the burner 5 (or the firebox 6).

Opening the valve 46 is piloted by regulation means 47 which controls the extent of opening of the valve 46 as a function of the measurement of the level of at least one combustible component included in the combustion gases.

This measurement is performed using a sensor 48. The level of methane will preferably be measured since this is the most reactive gas.

Another valve 49 may also be provided that will allow all or part of the gases to be evacuated outside or to a gas tank 50 (gasometer) to enable it to be stored temporarily in the event of an excessive production of volatile components.

The air used is preferably that which has been preheated by the refrigerating means 14.

We can see in FIGS. 1 and 2 that the hot gas generator 17 is supplied with gas by a ventilator 51 that is coupled with a closed circuit by a valve 52. It is thus possible for gas (in general, air) to be added to the circuit to compensate for any losses and to maintain the volume of gas necessary for good heat transfer.

A third condenser 53 is positioned between the ventilator 51 and the gas circuit. This condenser allows the external air used to be dried, thereby avoiding the production of water vapour in the circuit.

A fourth condenser 54 lastly enables the water extracted from the wood by the drying oven 12 to be eliminated from the hot gas circuit 19.

The third and fourth condensers are both linked to the refrigerating means 14 by refrigerated water circuits T53 and T54.

FIGS. 4 to 6 show the structure of the heat treatment oven used by the unit according to the invention.

The oven 4 is constituted in the form of a parallelepipedic block incorporating two lateral walls 55a and 55b arranged opposite one another as well as an upper wall 56. The oven 4 furthermore incorporates two doors 67e and 67s, water and gas tight and heat-insulated, enabling the passage of the wood-laden carriages.

These walls are made of sheet metal and are in the form of hollow box structures each deliminating a volume in which the combustion gases are able to circulate.

As may be seen more particularly in FIGS. 4a and 4b, the upper box structure 56 carries duct 8f which brings the combustion gases (Ge) as well as duct 9 which evacuates the gases (Gs) after their circulation in the oven 4.

These gases Gs (as specified above) are loaded with volatile organic compounds.

As may be seen in FIGS. 4a, 4b, 5a, 5b perforations 65 have been made in the lateral box structures 55a and 55b that allow the gases to pass from the lateral structure 55a or 55b in question to the inside of the oven 4.

The gases are thus introduced in the oven 4 via one of the lateral box structures (55a or 55b) and are evacuated from the oven through the other lateral box structure.

The upper box structure is additionally divided by partitions into two half-structures.

As may be seen more particularly in FIGS. 6a and 6b, the upper box structure 56 is divided into four compartments 57a, 57b, 58a and 58b by two partitions 59 and 60 which extend diagonally.

A first compartment 57a is linked to inlet duct 8f for the combustion gases Gs.

A second compartment 57b is lined to the evacuation duct 9 for the combustion gases Gs.

The two other compartments 58a and 58b are each linked to one of the lateral walls/box structures 55a or 55b.

Thus, we can see in the Figures that compartment 58a is linked to lateral box structure 55a and that compartment 58b is linked to box structure 55b (see also FIGS. 5a and 5b).

In accordance with one characteristic of the invention, each partition 59 and 60 is broken at its median part by a median pivoting shutter 61.

This shutter is controlled by a motor 62 and may be selectively positioned in the extension of one or other of the partitions 59 or 60.

It is thus possible using the shutter 61 to divide the upper box structure 56 into two half-structures and this in two different ways.

Thus, FIG. 6a shows the upper box structure 56 in a position in which the median shutter 61 is in a prolongation of partition 59.

In this position:

→ a first half-structure comprises the two compartments 57a and 58a,

→ a second half-structure comprises the two compartments 57b and 58b.

In such a configuration, the gases introduced in the oven by duct 8f are directed towards the lateral box structure 55a and they are evacuated by the lateral box structure 55b, after passing through the oven 4.

The movement of the gases in the oven 4 is that shown in FIG. 5a, that is to say from left to right.

Inversely, FIG. 6b shows the upper box structure 56 in a position in which the median shutter 61 is in the prolongation of partition 60.

In this position:

→ a first half-structure comprises the two compartments 57a and 58b,

→ a second half-structure comprises the two compartments 57b and 58a.

In such a configuration, the gases introduced in the oven by duct 8f are directed towards the lateral box structure 55b and they are evacuated by the lateral box structure 55a, after passing through the oven 4.

The movement of the gases in the oven 4 is that shown in FIG. 5b, that is to say from right to left.

The pivoting shutter 61 thus enables the combustion gases to be selectively directed towards one or other of the lateral walls/box structures 55a or 55b.

It is advantageous, in fact, during the heat treatment of the wood to vary the direction of cross flow of the combustion gases through the oven.

In fact, the treatment of the wood is thus homogenised. Cycles can be programmed during which the gaseous flow will be directed from one or other side of the load of wood.

Regardless of the cross direction of the gaseous flow inside the oven, it is useful to introduce the gases in the low part of the oven and to recover them in the upper part. Tightness to the volatile organic compounds is thus ensured.

To obtain such a result the perforations 65 are spaced over the full height of each lateral wall 55a, 55b.

Each wall is furthermore provided with a panel 66 that slides vertically on rails 63 by means of motorization 64.

The panel 66 is dimensioned so as to cover only one half of all of the perforations 65 in one wall.

It is thus possible, depending on the position selected for the panel 66, to block all the perforations 65 of an upper half (see FIG. 4a) or else all those of a lower half of said wall (see FIG. 4b).

Additionally, the means to control the motorization 64 are defined so that when a panel 66 is in its upper position on a wall, the panel of the other wall is arranged in the lower position.

These motorizations are furthermore coupled with those controlling the positioning of the shutter 61.

The purpose is for the gases always to be introduced inside the oven 4 from the lower position and evacuated from the upper position.

The positioning of the panels must thus be selected so as to always ensure a flow of combustion gases that passes through the oven from a lower part of a wall towards an upper part of the other wall.

By way of example we see on the Figures that when the combustion gases Ge are introduced in the lateral box structure 55a (see FIG. 6a) the panel 66 is in the upper position on this lateral wall, thereby unblocking the perforations of the lower part (FIGS. 5a and 4a). Inversely, the panel 66 is arranged in the lower position on lateral wall 55b.

The situation is reversed when the combustion gases Ge are introduced by box structure 55b (FIG. 6b). In this case, the panel 66 is in the upper position on this lateral wall, thereby unblocking the perforations in the lower part (FIG. 5b) and the panel 66 is arranged in the lower position on the lateral wall 55a (FIG. 4b).

Different variant are possible without departing from the scope of the invention.

It is possible for an oven of a different structure to be implemented, namely if the materials to be treated have a different shape and/or volume (for example for granular materials, such as chips).

It is also possible for the oven described with reference to FIGS. 4 to 6 to be implemented with a heat treatment unit of a different structure. For example, with a heat treatment unit according to prior art.

The structure of the oven proposed by the invention in fact enables a flow of combustion gas to be easily obtained that is oriented crosswise and directed from one wall of a box structure towards the other wall with the possibility of easily reversing the direction of the passage of the gaseous flow to homogenise the treatment. The gaseous cross flow may also always be oriented from the bottom to the top of the box structures even when the direction of flow in the oven is reversed.

It is also possible to implement refrigerating means of a different structure, for example using a fluid other than ammonia for the heat transfer. A classical compression refrigerating unit may be used implementing electrical energy. However, the absorption means proposed by the invention optimizes the use of the heat resources of the facility.

However, the solution proposed by the invention enables the heat efficiency to be optimised whilst supplying the drying ovens 12.

It is lastly possible for a unit in accordance with the invention to be used to perform the heat treatment of other types of material, for example organic materials or vegetal materials such as straw.

FIG. 7 shows another embodiment of a heat treatment unit 1 according to the invention.

In this embodiment, the firebox 6 is also heated by a burner (not shown) and the combustion gases are cooled upon their exiting the firebox 6 by the first condenser 11. As in the previous embodiment, condensation enables part of the dust contained in the combustion gases to be eliminated along with the water. The water thus loaded with dust is evacuated by a duct 70 towards decantation means 13. The water is evacuated by a collector 94 towards a treatment unit 95.

As in the previous embodiment, the condenser 11 is cooled by absorption refrigerating means 14 using the firebox 6 as a heat source. In FIG. 7 the dotted lines represent the ducts Ca of the heat-conducting circuit linking the refrigerating means 14 to the boiler 35 that is heated by the combustion gases. Lastly, FIG. 7 shows the refrigerating circuit T11 that links the refrigerating means 14 to the first condenser 11.

This embodiment differs from the previous one in that the superheater 16 is here constituted by an exchanger arranged in the firebox 6 and heated by the burner itself.

Thus, during the normal functioning of the facility, the combustion gases cooled by the condenser 11 are conducted by piping 71 towards the superheater 16. A valve 72 enables this branch of the facility to be isolated. After exiting the superheater 16, the hot combustion gases are brought to the mixing valves 74 and 75 by a duct 77 that is divided into two branches 77a and 77b.

Furthermore, a branch 73 that divides into two sub-branches 73a and 73b also conducts part of the cool gases exiting the condenser 11 to the two mixing valves 74 and 75.

A valve 76 enables this branch conducting the cool gases to be isolated.

The treatment unit according to this embodiment thus comprises two separate circuits conducting the combustion gases from the condenser 11:

A cool circuit (73, 73a, 73b) shown in broken lines in FIG. 7.

A hot circuit (77, 77a, 77b) shown in full lines in FIG. 7.

Arrows enable the direction of the gas flow to be visualised for the different circuits during the normal functioning of the unit.

According to this embodiment of the invention, the temperature required for the treatment (or to dry the wood) will be regulated by dosing, by the mixing valves 74, 75, the mixture of the cool combustion gases and the superheated combustion gases.

The mixing valves 74 and 75 are linked to the electronic temperature regulation means 23. Means 23 are also used to control the opening or closing of valves 72 and 76 enabling the different circuits to be isolated.

Means 23 lastly ensure the control of two pumps 78 and 79. Each of these pumps is arranged on a separate hot or cold circuit and enables the gas flow to be regulated in the circuit in question. Pump 78 is thus arranged on the cold circuit 73 and pump 79 on the hot circuit (but upstream of the exchanger 16).

It is in fact essential for the sum of the gas flow circulating in each of the circuits 73, 77 to be equal to the flow of gas exiting the condenser 11 so as not to smother the combustion. The exhaust shaft draught is thus ensured by maintaining negative pressure in the firebox.

Furthermore, the pump 79 enables the flow rate of the gases circulating in the exchanger 16 to be regulated thereby ensuring the highest possible heat efficiency.

Flow rate sensors (not shown) are arranged on the different circuits (flow rate sensors on circuits 73, 77 and at the outlet to the condenser 11). Temperature sensors (not shown) are also provided in the ovens 4, 12. All these sensors are linked to the regulation means 23 so as to enable them to ensure their function.

The mixing valves 74, 75 thus enable, by dosing the mixture of hot and cold gases, the required temperature to be obtained in each oven 4 or 12.

This embodiment of the invention enables the heat efficiency to be yet further improved. In fact, the heat energy supplied by the firebox 6 is directly used to superheat the combustion gases. The mixing valves 74, 75 enables the temperature of the gases directed to the ovens to be finely regulated over a wide regulation range (the combustion gas circulating in the cool circuit has a temperature of around 80° C. whereas the hot gas has a temperature of around 500° C.).

This flexibility with respect to the temperature regulation (which namely allows the necessary stages of temperature increase or decrease to be programmed) allow a single heat facility to be used to supply with hot gas different ovens 4 or dryers 12 that have very different temperatures of use.

By way of a variant, a set of manifolds structurally incorporated into a hot gas generator such as that described with reference to FIGS. 1 and 2 and by patent application FR06-05589 can be used by way of a superheater 16.

It would thus be possible to use the heat energy from the firebox 6 to ensure both the superheating of the combustion gases and the production of a hot gas separate from the combustion gas (and able to be used by other applications, as heating for the premises or for other drying ovens).

The regulation of the mixing valves 74 and 75 leads, however, to a pressure drop in the different combustion gas circuits. To compensate for such pressure drops and thus to ensure a balancing of the pressures and the maintenance of a negative pressure at a constant value in the firebox 6 a balance circuit is provided for each hot or cool combustion gas circuit.

This balance circuit enables part of the hot or cool gases to be re-injected upstream of the pump in the circuit in question.

Thus, in the hot gas circuit 77 there is a branch 80, 83 that is connected to circuit 77 by a valve 81 and by a three-way stopcock 82. Part of the hot gases taken upstream of the mixing valves 74, 75 are thus redirected, after exiting the stopcock 82 by piping 83, upstream of pump 79.

In the cool gas circuit 73 there is a branch 84, 85 that is connected to circuit 73 by a valve 86 and a three-way stopcock 87. Part of the cool gases taken upstream of the mixing valves 74, 75 is thus redirected, after exiting the stopcock 87 by piping 85, upstream of pump 78.

Valves 81, 86 and stopcocks 82, 87 are controlled by the regulation means 23 according to the measurement of the negative pressure in the firebox 6 such measurement being performed using a suitable sensor (not shown). In fact, it is easier to measure a negative pressure in the firebox than to measure the flow of gas generated by the combustion then treated by the condenser 11. In the functioning mode thus described, it is by controlling the negative pressure above the firebox, which enables the combustion rate, thus the flow of gases generated, to be regulated.

These balance circuits enable the flow of hot or cool gases to be regulated despite any modification made during functioning to the regulation of the mixing valves 74, 75.

FIG. 7 schematically shows two ovens: a drying oven 12 and a treatment oven 4.

Each oven is supplied with combustion gas at a temperature that is regulated using a separate mixing valve 74 or 75.

According to this embodiment of the invention, the structure of each oven is simplified.

FIGS. 9a and 9b show an enlargement of the structure of ovens 4 and 12.

Such an oven comprises two lateral walls 55a, 55b opposite one another. These walls are made in the form of box structures in which the combustion gases circulate. However, here each lateral wall is divided into two separate half-structures 55a1, 55a2 and 55b1, 55b2.

A lower box structure 55a1 or 55b1 is intended to receive the combustion gases which are supplied by the mixing valves 74 or 75.

An upper box structure 55a2 or 55b2 enables the gases to be collected for their evacuation after their passage in the oven 4, 12.

So as to control the direction of flow of the gases inside the oven, a three-way valve 88 or 89 is arranged upstream of the lower box structures 55a1, 55b1. Another three-way valve 90 or 91 is arranged downstream of the upper box structures 55a2, 55b2.

It is thus possible to ensure, through the control of the two valves in the oven in question, the control of the direction in which the gases (G) pass from one partition 55a to the other 55b.

FIG. 9a thus shows an oven in which the gases circulate from right to left. The three-way valve 88, 89 is piloted to direct the combustion gases towards the lower right box structure 55b1. The gases exit this structure through perforations 65 and they move in the direction shown by the arrows towards the upper left box structure 55a2. In fact, the valve 90, 91 has been piloted so as to isolate the upper right box structure 55b2 and link the upper left box structure to the gas evacuation circuit (towards the second condenser 41).

The inactive box structures are shaded in FIGS. 9a, 9b. With this embodiment of the invention, it is no longer necessary to provide a sliding shutter to block the perforations in the walls. The gases naturally follow the path made accessible to them.

With reference to FIG. 9b, we see that by inverting the directions of valves 88, 89 and 90, 91 the gas flow occurs in the opposite direction: from the lower left box structure 55a1 towards the upper right box structure 55b2.

Such an embodiment of the ovens is simpler in design and is more robust than the one described previously with reference to FIGS. 4 to 6. It also enables the sealing of the ovens to be made easier thereby limiting any leakage and loss of gas.

FIG. 7 shows, downstream of the ovens, the second condensers 41 that enable the water incorporated into the gases after exiting the ovens to be eliminated.

These condensers 41 are linked to the refrigerating means 14 by manifolds T41. The water loaded with residue is received in tanks 92, 93. We note in FIG. 7 that (the oven 12 being a drying oven) the gases exiting the oven 12 incorporate only water and the latter may be conducted from the tank 92 outlet directly to a collector 94 which then conducts the water to a treatment plant 95.

The oven 4 is a wood heat treatment oven, the condensate of the gases exiting this oven thus incorporate numerous volatile organic compounds such as condensable hydrocarbons. Tank 93 is thus linked to decantation means 42 (for example of the overflow oil separator type) that separate the water and oils (or fatty acids) which are then recovered in a tank 44 with a view to their subsequent reuse (reclaiming for use in the chemical industry or use as a fuel).

The water from means 42 is evacuated toward the collector 94. The gaseous fractions of the effluents may be recovered and conducted to the burner as has been described with reference to the previous embodiment.

FIG. 7 shows that the second condensers 41 are linked downstream to a collector 100 to evacuate the gases into the atmosphere. This collector incorporates a ventilator 43 (or ventilation unit) that enables the flow rate of the gases in the ovens 4, 12 to be regulated. This regulation is completed with the aid of venturis 96 and 97 ensuring a slight negative pressure in the ovens 4, 12. The level of negative pressure is adjusted using valves 98 and 99 that are controlled by the control means 23.

Valves 98, 99 thus enable the gas flow rate in the ovens to be finely regulated. It is, in fact, preferable for this flow rate to be as low as possible (a few tens of centimetres per second) such that the heat treatment performed closely resembles steaming which avoids the twisting and bursting or the organic materials (wood) being treated.

Valves 98 and 99 may be positioned upstream of the second condensers 41. It would thus be preferable to associate several ovens with one and the same condenser 41. Each valve 98, 99 will, in this case, individually ensure the control of the gas flow in the oven to which it is associated.

We observe from the above description that this embodiment of the invention is particularly economical and enables the heat energy supplied by the firebox to be used optimally, both to generate an oxygen-depleted gas and to heat and regulate its temperature and its circulation in the ovens.

This embodiment, however, requires a specific starting phase that will now be described with reference to FIG. 8.

During this starting phase, it is necessary to prime the functioning of the absorption refrigerating means 14. The latter must reach an operating regime that produces a given temperature in the condenser 11 (of between 5° C. and 20° C.) enabling the condensation of the impurities in the combustion gases to be performed.

The starting phase will thus use the heat energy of the burner to prime the functioning of the refrigerating means. It is, in fact, the exchanger 35 that collects the heat energy required by the refrigerating means 14.

During this starting phase, the ovens 4, 12 are completely cut off from the gas circuits.

Valves 72 and 76 are thus closed and the combustion gases do not circulate in the cool circuit 73. Mixing valves 74 and 75 are, furthermore, in a position in which they isolate the ovens 4 and 12.

FIG. 8 shows the active gas circuits in full lines and the inactive gas circuits in dotted lines.

Pumps 78 and 79 are stopped. A non-return valve 104 is positioned between the pump 79 and the hot circuit 77 upstream of the superheater 16.

Thus, the combustion gases exiting the firebox are conducted directly through the piping 103 to the free air. A valve 102 has been opened for this and the three-way stopcock 87 has been positioned so as to cut off the balance circuit 84, 85.

The only function of the combustion gases is thus to prime the refrigerating means thanks to the exchanger 35.

The superheater 16 circuit thus does not receive the combustion gas flow during the starting phase. So as to avoid deteriorating it during this phase, dehydrated fresh air is made to circulate in it. This air is supplied by a ventilation unit 106 via a non-return valve 105 and it supplies the superheater 16. The air is dehydrated by means of a condenser 107 and specific refrigerating means (conventional compressor refrigerating means). The condensed water is evacuated towards the decantation means 13.

The non-return valves 104 and 105 ensure that the fresh air circuits of the starting phase and the combustion gases are isolated from each other. It is enough to prevent the passage of air supplied by the ventilation unit 106 to the pump 79 (valve 104) and inversely to prevent a return of the combustion gas from the superheater 16 towards the ventilation unit 106 during permanent functioning (valve 105).

The dehydrated air is thus conducted towards the superheater 16 and passes through the hot circuit 77. It is not able to go towards the ovens (mixing valves 74, 75 are closed) and it takes circuit 80, via valve 81 which is open. The three-way stopcock 82 is positioned such that this air heated by the firebox 6 is evacuated to the free air through piping 103.

A condenser 101 is arranged on circuit 80. This condenser is linked to the absorption refrigerating means 14 (in parallel with the main exchanger or boiler 35). It ensures additional recovery of the heat carried by the hot air. The quick start of the refrigerating means 14 is thus facilitated.

The heated air from circuit 80 may be conducted to the firebox 6 to ensure preheating.

When the temperature in the condenser 11 has reached the required value (of between 5° C. and 20° C.), valves 72 and 76 open progressively whereas valve 102 closes progressively and pumps 78 and 79 start up (and the ventilation unit 106 stops). The different valves and mixers and thereafter controlled so as to balance the flows depending on the temperatures required for the ovens.

When valve 102 is completely closed and the ventilation unit 106 has stopped, the starting phase has finished.

1. A heat treatment process for a material in an oven, and namely an organic material such as wood, process using the combustion gases supplied by at least one burner associated with a firebox, process wherein a first condensation phase is provided for the combustion gases between their exiting the firebox and entering the oven, such condensation enabling part of the dust contained in the combustion gases to be eliminated, the first condensation phase being conducted using absorption refrigerating means followed by a superheating phase of the combustion gas allowing the required temperature to be obtained for the heat treatment.

2. A heat treatment process according to claim 1, wherein the superheating is performed using the gases supplied by a hot gas generator which is itself heated by the burner.

3. A heat treatment process according to claim 1, wherein the superheating is made via an exchanger heated by the burner.

4. A heat treatment process according to claim 2, wherein the temperature of the combustion gases used for the treatment is regulated by mixing gases exiting the superheating phase with those from the first condensation phase.

5. A heat treatment process according to claim 1, wherein a second condensation phase is performed at the oven outlet.

6. A heat treatment process according to claim 5, wherein the second condensation phase is followed by a phase to separate the solid and/or liquid fraction and the combustion gases themselves.

7. A heat treatment process according to claim 6, wherein the combustion gases are redirected after exiting the separation phase towards the burner and/or the firebox, by means of a mixing phase that ensures the mixture of the gases and the air, such mixture being proportioned as a function of the measurement of the level of at least one combustible included in the combustion gases.

8. A heat treatment unit for a material, and namely for an organic material such as wood, such unit comprising at least one oven, heated by combustion gases from at least one burner associated with a firebox, wherein it incorporates at least a first condenser that is arranged so as to cool the combustion gases exiting the firebox, such condensation enabling part of the dusts contained in the combustion gases to be eliminated with the water, such dusts being recovered by decantation means, such unit incorporating at least one superheater linked to heating means and enabling the combustion gases to be heated after exiting the first condenser, and also incorporating at least one absorption refrigerating means that uses the firebox as a heat source and that comprises at least one cooling circuit coupled with the first condenser.

9. A heat treatment unit according to claim 8, wherein the heating means are linked to the superheater by means of temperature regulation means for the combustion gases.

10. A heat treatment unit according to claim 9, wherein the heating means are linked to a hot gas generator, which is itself heated by the burner(s).

11. A heat treatment unit according to claim 10, wherein the superheater comprises at least two hot gas circulation circuits arranged in a chamber through which the combustion gases circulate, the circuits being arranged such that the combustion gases circulate in the opposite direction to the hot gases supplied by the gas generator, each circuit being furthermore equipped with a valve to regulate the gas flow whose opening is controlled by the temperature regulation means.

12. A heat treatment unit according to claim 9, wherein the superheater is constituted by an exchanger heated by the burner itself.

13. A heat treatment unit according to claim 12, wherein the exchanger forming the superheater incorporates manifolds which are structurally incorporated into a hot gas generator.

14. A heat treatment unit according to claim 12, wherein the temperature regulation means for the combustion gases comprise two circuits: one circuit for the cold combustion gases from the first condenser and another circuit for the hot combustion gases from the superheater, the temperature of the combustion gases used being regulated by at least one mixing valve ensuring the mixture of the cold and hot gases.

15. A heat treatment unit according to claim 14, wherein the hot and cold circuit incorporates a pump, the pump rate being regulated so as to ensure the equality of the combustion gas flow upstream and downstream of the superheater.

16. A heat treatment unit according to claim 14, wherein each circuit of hot or cold combustion gases incorporates a balance circuit enabling any drop in pressure caused by the mixing valve to be compensated for, such balance circuit re-injecting part of the hot or cold gases upstream of the pump of the circuit in question.

17. A heat treatment unit according to claim 6, wherein it incorporates at least a second condenser which is arranged at the oven outlet.

18. A heat treatment unit according to claim 17, wherein it comprises decantation means enabling the solid and/or liquid fraction to be separated from the gases themselves.

19. A heat treatment unit according to claim 18, wherein it comprises a mixing phase that ensures the mixing with air of the gases exiting the second condenser and the decantation means, this mixing phase incorporating at least one valve whose opening will be controlled by regulation means that will control the degree to which the valve opens according to the measurement of the level of at least one combustible component included in the combustion gases, the mixture of air and combustion gases being redirected towards the burner and/or the firebox.

20. A heat treatment unit according to claim 17, wherein at least one cooling circuit for the absorption refrigerating means is also coupled with the second condenser.

21. A heat treatment unit according to claim 8, wherein the hot gas generator is supplied with air via a third condenser connected to a cooling circuit of the absorption refrigerating means.

22. A heat treatment unit according to claim 6, wherein it comprises at least one oven that incorporates two lateral walls opposite one another and an upper wall, such walls being made in the form of box structures in which the combustion gases circulate, the latter being brought to the upper box structure which is divided into two half-box structures, one half-box structure receiving the combustion gases from the oven and the other half-box structure collecting the gases for their evacuation after their passage in the oven, each half-box structure furthermore communicating with a separate lateral box structure, the walls of the lateral box structures being provided with perforations enabling the gases from the lateral box structure to pass into the inside of the oven, the gases being thus introduced in the oven by a lateral box structure and being evacuated from the oven by the other lateral box structure.

23. A heat treatment unit according to claim 22, wherein the upper box structure is roughly parallelepipedic in shape and is divided into four compartments by two partitions which extend diagonally, a first compartment being linked to a combustion gas inlet pipe and a second compartment being linked to a combustion gas outlet pipe, the two other compartments each being linked to one of the lateral box structures, a median pivoting shutter is positioned either in the prolongation of one or other of the diagonal partitions so as to divide the upper box structure into two half-box structures, the pivoting shutter thus enables the combustion gases to be directed selectively either towards one or other of the lateral box structures.

24. A heat treatment unit according to claim 23, wherein the lateral box structures are provided with perforations which are spaced over the full height of each box structure, each lateral box structure being furthermore equipped with a vertically sliding panel that, depending on the position selected, enables all the perforations of an upper half or else all those of a lower half of said lateral box structure to be blocked, the panels being furthermore positioned in the upper position on one lateral box structure and in the lower position on the other lateral box structure depending on the position of the pivoting shutter in the upper box structure, the positioning of the panels being selected so as to constantly ensure a flow of combustion gases that pass through the oven from a lower part of a lateral box structure towards an upper part of the other lateral box structure.

25. A heat treatment unit according to claim 6, wherein it comprises at least one oven that incorporates two lateral walls opposite one another, walls which are made in the form of box structures in which the combustion gases flow, each lateral wall being divided into two half-box structures, a lower box structure intended to receive the combustion gases from the oven and an upper box structure collecting the gases for their evacuation after their passage in the oven, one three-way valve being positioned upstream of the lower box structure and another three-way valve being positioned downstream of the upper box structures so as to ensure, through the activation of the two valves, the control of the direction in which the gases pass from one partition towards the other partition.

26. A heat treatment unit according to claim 25, wherein downstream of the second condenser at the outlet to the oven at least one ventilation unit is provided coupled with a venturi that enables the oven to be maintained at negative atmospheric pressure, a valve positioned downstream of the oven enabling the gas flow through the oven to be regulated.
